(19) United States
(12) Patent Application Publication
(10) Pub. No.: US 2021/0058211 A1
(43) Pub. Date: Feb. 25, 2021

(54) MULTIPLEXING DEMODULATION REFERENCE SIGNALS AND SYNCHRONIZATION SIGNALS IN NEW RADIO

(71) Applicant: QUALCOMM Incorporated, San Diego, CA (US)

(72) Inventors: Sony AKKARAKARAN, Poway, CA (US); Tao LUO, San Diego, CA (US); Alexandros MANOLAKOS, Escondido, CA (US); Peter GAAL, San Diego, CA (US); Juan MONTOJO, San Diego, CA (US)

(21) Appl. No.: 17/090,258

(22) Filed: Nov. 5, 2020

Related U.S. Application Data
(63) Continuation of application No. 16/040,134, filed on Jul. 19, 2018.

(30) Foreign Application Priority Data
Jul. 21, 2017 (GR) 20170100344

(51) Int. Cl. H04L 5/00; H04J 11/00

(52) U.S. Cl. CPC H04L 5/0048; H04L 5/0091; H04W 72/042; H04J 11/0023; H04L 5/0023

(57) ABSTRACT

Certain aspects of the present disclosure relate to methods and apparatus methods and apparatus for multiplexing demodulation reference signals (DMRS) and synchronization signals (SS) in new radio (NR). An exemplary method that may be performed by a base station (BS) includes determining transmission resources, in a set of slots, to be used for first demodulation reference signals (DMRS), based on whether synchronization signals (SS) are to be transmitted in the set of slots, and transmitting the first DMRS using the transmission resources in the set of slots.

### CROSS-REFERENCE TO RELATED APPLICATIONS

This application is a continuation of U.S. application Ser. No. 16/040,134, filed Jul. 19, 2018, which claims benefit of and priority to Greek Application No. 20170100344, filed Jul. 21, 2017, which is assigned to the assignee hereof and hereby expressly incorporated by reference herein in its entirety.

### BACKGROUND

### Field of the Disclosure

The present disclosure relates generally to wireless communication systems, and more particularly, to methods and apparatus for multiplexing demodulation reference signals (DMRS) and synchronization signals (SS) in new radio (NR).

### Description of Related Art

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include Long Term Evolution (LTE) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

In some examples, a wireless multiple-access communication system may include a number of base stations, each simultaneously supporting communication for multiple communication devices, otherwise known as user equipment (UEs). In LTE or LTE-A network, a set of one or more base stations may define an eNodeB (eNB). In other examples (e.g., in a next generation or 5^{th} generation (5G) network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more distributed units, in communication with a central unit, may define an access node (e.g., a new radio base station (NR BS), a new radio node-B (NR NB), a network node, 5G NB, eNB, etc.). A base station or DU may communicate with a set of UEs on downlink channels (e.g., for transmissions from a base station or to a UE) and uplink channels (e.g., for transmissions from a UE to a base station or distributed unit).

These multiple access technologies have been adopted in various telecommunication standards to provide a common protocol that enables different wireless devices to communicate on a municipal, national, regional, and even global level. An example of an emerging telecommunication standard is new radio (NR), for example, 5G radio access. NR is a set of enhancements to the LTE mobile standard promulgated by Third Generation Partnership Project (3GPP). It is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL) as well as support beamforming, multiple-input multiple-output (MIMO) antenna technology, and carrier aggregation.

However, as the demand for mobile broadband access continues to increase, there exists a desire for further improvements in NR technology. Preferably, these improvements should be applicable to other multi-access technologies and the telecommunication standards that employ these technologies.

### BRIEF SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects provide a method for wireless communications by a base station (BS). The method generally includes determining transmission resources, in a set of slots, to be used for first demodulation reference signals (DMRS), based on whether synchronization signals (SS) are to be transmitted in the set of slots, and transmitting the first DMRS using the transmission resources in the set of slots.

Certain aspects provide a method for wireless communications by a user equipment (UE). The method generally includes determining transmission resources in a set of slots to be used for first demodulation reference signals (DMRS), based on whether synchronization signals (SS) are to be transmitted in the set of slots, and processing signaling in the set of slots based on the DMRS in the transmission resources.

Certain aspects provide an apparatus for wireless communications. The apparatus generally includes a processor configured to determine transmission resources, in a set of slots, to be used for first demodulation reference signals (DMRS), based on whether synchronization signals (SS) are to be transmitted in the set of slots and to cause the apparatus to transmit the first DMRS using the transmission resources in the set of slots; and a memory coupled with the processor.

Certain aspects provide an apparatus for wireless communications. The apparatus generally includes a processor configured to determine transmission resources in a set of slots to be used for first demodulation reference signals (DMRS), based on whether synchronization signals (SS) are to be transmitted in the set of slots and to process signaling in the set of slots based on the DMRS in the transmission resources; and a memory coupled with the processor.

Certain aspects provide an apparatus for wireless communications. The apparatus generally includes means for determining transmission resources, in a set of slots, to be used for first demodulation reference signals (DMRS), based on whether synchronization signals (SS) are to be transmitted in the set of slots, and means for transmitting the first DMRS using the transmission resources in the set of slots.

Certain aspects provide an apparatus for wireless communications. The apparatus generally includes means for determining transmission resources in a set of slots to be used for first demodulation reference signals (DMRS), based on whether synchronization signals (SS) are to be transmitted in the set of slots, and means for processing signaling in the set of slots based on the DMRS in the transmission resources.

Certain aspects provide a computer-readable medium. The computer-readable medium generally includes instructions that, when executed by a processing system, cause the processing system to perform operations that generally include determining transmission resources, in a set of slots, to be used for first demodulation reference signals (DMRS), based on whether synchronization signals (SS) are to be transmitted in the set of slots, and transmitting the first DMRS using the transmission resources in the set of slots.

Certain aspects provide a computer-readable medium. The computer-readable medium generally includes instructions that, when executed by a processing system, cause the processing system to perform operations that generally include determining transmission resources in set of slots to be used for first demodulation reference signals (DMRS), based on whether synchronization signals (SS) are to be transmitted in the set of slots, and processing signaling in the set of slots based on the DMRS in the transmission resources.

Aspects generally include methods, apparatus, systems, computer readable mediums, and processing systems, as substantially described herein with reference to and as illustrated by the accompanying drawings.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram illustrating an example logical architecture of a distributed RAN, in accordance with certain aspects of the present disclosure.

FIG. 3 is a diagram illustrating an example physical architecture of a distributed RAN, in accordance with certain aspects of the present disclosure.

FIG. 4 is a block diagram conceptually illustrating a design of an example BS and user equipment (UE), in accordance with certain aspects of the present disclosure.

FIG. 5 is a diagram showing examples for implementing a communication protocol stack, in accordance with certain aspects of the present disclosure.

FIG. 6 illustrates an example of a downlink-centric (DL-centric) subframe, in accordance with certain aspects of the present disclosure.

FIG. 7 illustrates an example of an uplink-centric (UL-centric) subframe, in accordance with certain aspects of the present disclosure.

FIGS. 8A & 8B illustrate exemplary transmission timelines, in accordance with aspects of the present disclosure.

FIG. 9 illustrates example operations for wireless communications by a base station (BS), in accordance with certain aspects of the present disclosure.

FIG. 10 illustrates example operations for wireless communications by a user equipment (UE), in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure relate to methods and apparatus for multiplexing demodulation reference signals (DMRS) and synchronization signals (SS) in new radio (NR), also referred to as 3^{rd} Generation Partnership Project (3GPP) 5^{th} Generation (5G) radio access technology. The synchronization signals may include primary synchronization signals (PSS), physical broadcast channels (PBCH), and secondary synchronization signals (SSS).

NR may support various wireless communication services, such as enhanced mobile broadband (eMBB) service targeting wide bandwidth (e.g., 80 MHz and wider) communications, millimeter wave (mmW) service targeting high carrier frequency (e.g., 27 GHz and higher) communications, massive machine type communications (mMTC) targeting non-backward compatible machine type communications (MTC) techniques, and/or mission critical (MiCr) service targeting ultra-reliable low latency communications (URLLC). These services may include latency and reliability requirements. These services may also have different transmission time intervals (TTI) to meet respective quality of service (QoS) requirements. In addition, these services may co-exist in the same subframe.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication networks such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). NR is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

### Example Wireless Communications System

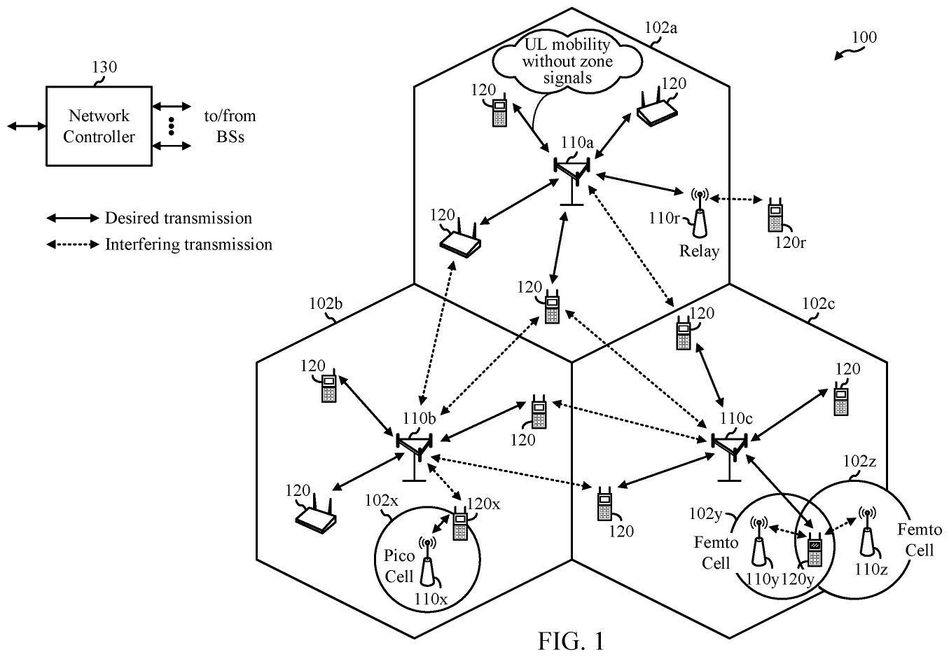

FIG. 1 illustrates an example wireless network 100, such as a new radio (NR) or 5G network, in which aspects of the present disclosure may be performed.

As illustrated in FIG. 1, the wireless network 100 may include a number of BSs 110 and other network entities. A BS may be a station that communicates with UEs. Each BS 110 may provide communication coverage for a particular geographic area. In 3GPP, the term “cell” can refer to a coverage area of a Node B and/or a Node B subsystem serving this coverage area, depending on the context in which the term is used. In NR systems, the term “cell” and eNB, Node B, 5G NB, AP, NR BS, NR BS, or TRP may be interchangeable. In some examples, a cell may not necessarily be stationary, and the geographic area of the cell may move according to the location of a mobile base station. In some examples, the base stations may be interconnected to one another and/or to one or more other base stations or network nodes (not shown) in the wireless network 100 through various types of backhaul interfaces such as a direct physical connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a frequency channel, etc. Each frequency may support a single RAT in a given geographic area in order to avoid interference between wireless networks of different RATs. In some cases, NR or 5G RAT networks may be deployed.

A BS may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BS for the femto cells 102y and 102z, respectively. A BS may support one or multiple (e.g., three) cells.

The wireless network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

The wireless network 100 may be a heterogeneous network that includes BSs of different types, e.g., macro BS, pico BS, femto BS, relays, etc. These different types of BSs may have different transmit power levels, different coverage areas, and different impact on interference in the wireless network 100. For example, macro BS may have a high transmit power level (e.g., 20 Watts) whereas pico BS, femto BS, and relays may have a lower transmit power level (e.g., 1 Watt).

The wireless network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may be coupled to a set of BSs and provide coordination and control for these BSs. The network controller 130 may communicate with the BSs 110 via a backhaul. The BSs 110 may also communicate with one another, e.g., directly or indirectly via wireless or wireline backhaul.

The UEs 120 (e.g., 120x, 120y, etc.) may be dispersed throughout the wireless network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered evolved or machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices. In FIG. 1, a solid line with double arrows indicates desired transmissions between a UE and a serving BS, which is a BS designated to serve the UE on the downlink and/or uplink. A dashed line with double arrows indicates interfering transmissions between a UE and a BS.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth (e.g., system frequency band) into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a ‘resource block’) may be 12 subcarriers (or 180 kHz). Consequently, the nominal FFT size may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

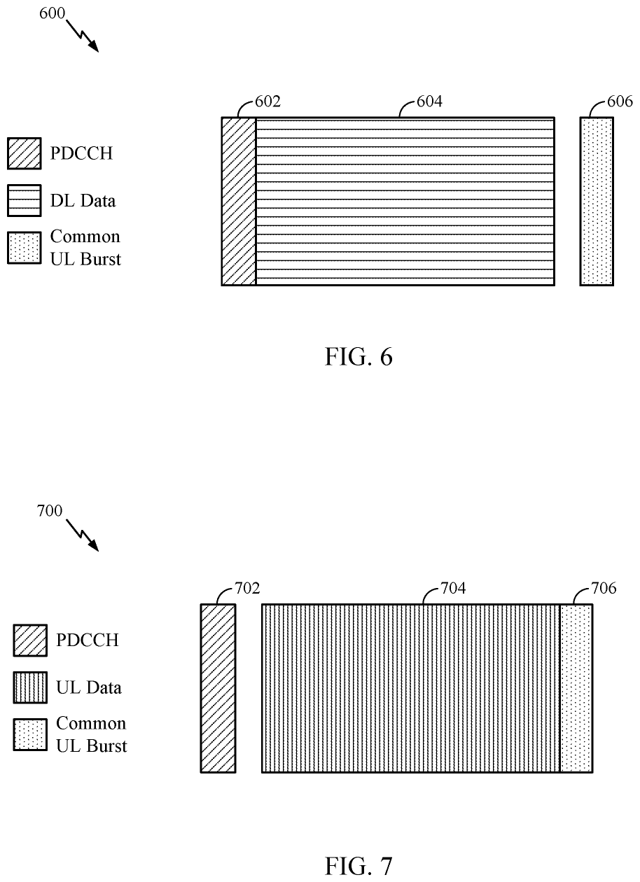

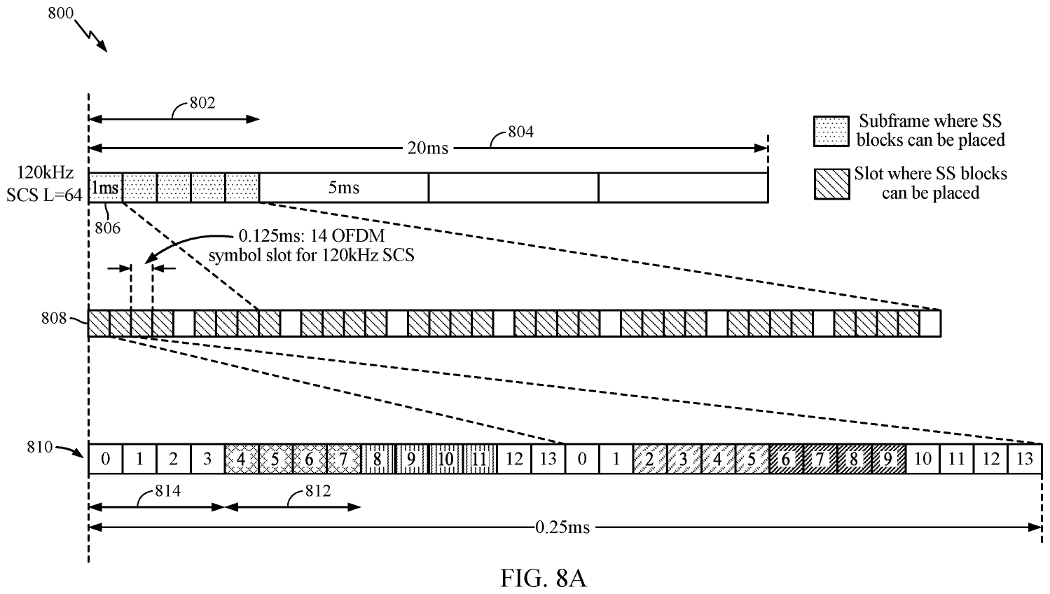

While aspects of the examples described herein may be associated with LTE technologies, aspects of the present disclosure may be applicable with other wireless communications systems, such as NR. NR may utilize OFDM with a CP on the uplink and downlink and include support for half-duplex operation using time division duplex (TDD). A single component carrier bandwidth of 100 MHz may be supported. NR resource blocks may span 12 sub-carriers with a sub-carrier bandwidth of 75 kHz over a 0.1 ms duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. UL and DL subframes for NR may be as described in more detail below with respect to FIGS. 6 and 7. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells. Alternatively, NR may support a different air interface, other than an OFDM-based. NR networks may include entities such CUs and/or DUs.

In some examples, access to the air interface may be scheduled, wherein a scheduling entity (e.g., a base station) allocates resources for communication among some or all devices and equipment within its service area or cell. Within the present disclosure, as discussed further below, the scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. That is, in some examples, a UE may function as a scheduling entity, scheduling resources for one or more subordinate entities (e.g., one or more other UEs). In this example, the UE is functioning as a scheduling entity, and other UEs utilize resources scheduled by the UE for wireless communication. A UE may function as a scheduling entity in a peer-to-peer (P2P) network, and/or in a mesh network. In a mesh network example, UEs may optionally communicate directly with one another in addition to communicating with the scheduling entity.

Thus, in a wireless communication network with a scheduled access to time-frequency resources and having a cellular configuration, a P2P configuration, and a mesh configuration, a scheduling entity and one or more subordinate entities may communicate utilizing the scheduled resources.

As noted above, a RAN may include a CU and DUs. A NR BS (e.g., eNB, 5G Node B, Node B, transmission reception point (TRP), access point (AP)) may correspond to one or multiple BSs. NR cells can be configured as access cell (ACells) or data only cells (DCells). For example, the RAN (e.g., a central unit or distributed unit) can configure the cells. DCells may be cells used for carrier aggregation or dual connectivity, but not used for initial access, cell selection/reselection, or handover. In some cases DCells may not transmit synchronization signals—in some case cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

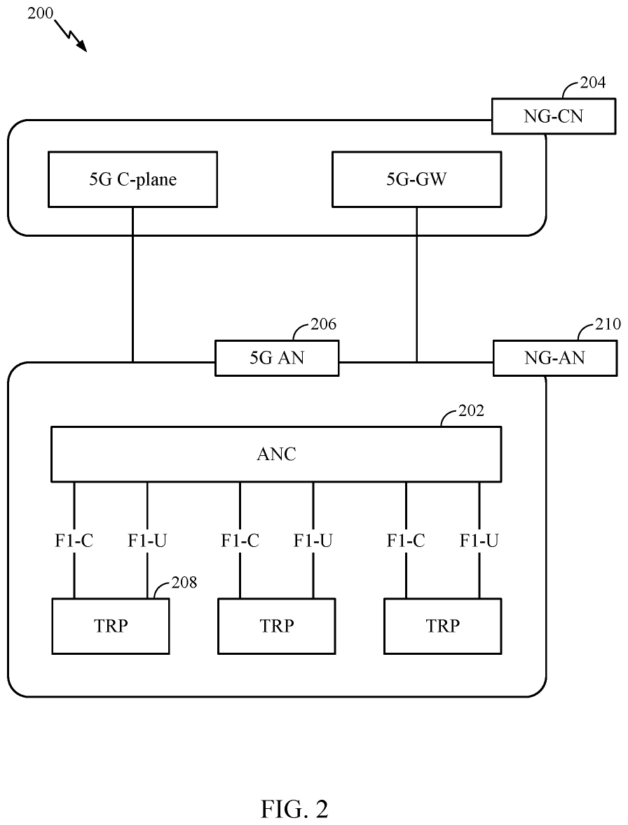

FIG. 2 illustrates an example logical architecture of a distributed radio access network (RAN) 200, which may be implemented in the wireless communication system illustrated in FIG. 1. A 5G access node 206 may include an access node controller (ANC) 202. The ANC may be a central unit (CU) of the distributed RAN 200. The backhaul interface to the next generation core network (NG-CN) 204 may terminate at the ANC. The backhaul interface to neighboring next generation access nodes (NG-ANs) may terminate at the ANC. The ANC may include one or more TRPs 208 (which may also be referred to as BSs, NR BSs, Node Bs, 5G NBs, APs, or some other term). As described above, a TRP may be used interchangeably with “cell.”

The TRPs 208 may be a DU. The TRPs may be connected to one ANC (ANC 202) or more than one ANC (not illustrated). For example, for RAN sharing, radio as a service (RaaS), and service specific AND deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture 200 may be used to illustrate fronthaul definition. The architecture may be defined that support fronthauling solutions across different deployment types. For example, the architecture may be based on transmit network capabilities (e.g., bandwidth, latency, and/or jitter).

The architecture may share features and/or components with LTE. According to aspects, the next generation AN (NG-AN) 210 may support dual connectivity with NR. The NG-AN may share a common fronthaul for LTE and NR.

The architecture may enable cooperation between and among TRPs 208. For example, cooperation may be preset within a TRP and/or across TRPs via the ANC 202. According to aspects, no inter-TRP interface may be needed/present.

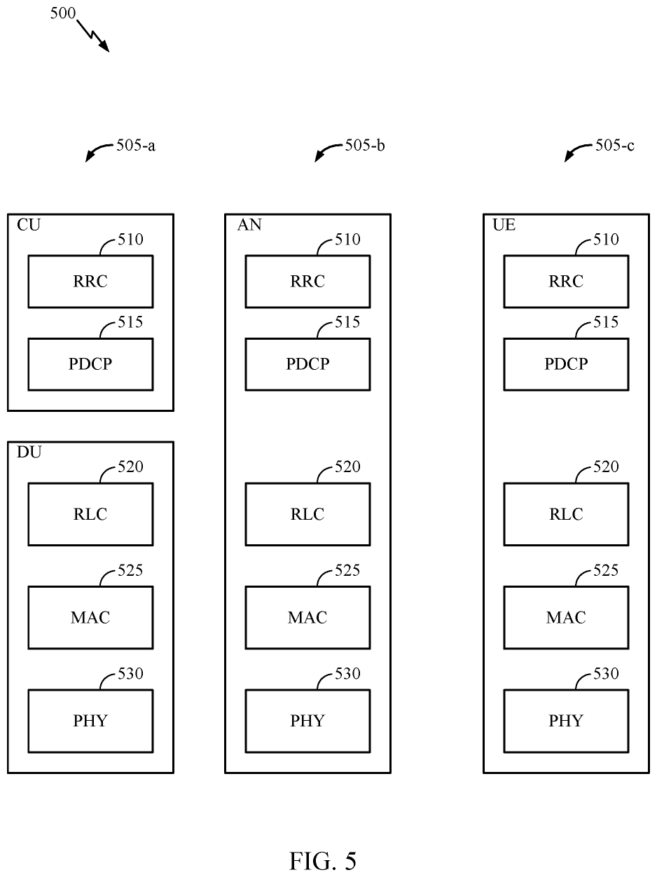

According to aspects, a dynamic configuration of split logical functions may be present within the architecture 200. As will be described in more detail with reference to FIG. 5, the Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU or CU (e.g., TRP or ANC, respectively). According to certain aspects, a BS may include a central unit (CU) (e.g., ANC 202) and/or one or more distributed units (e.g., one or more TRPs 208).

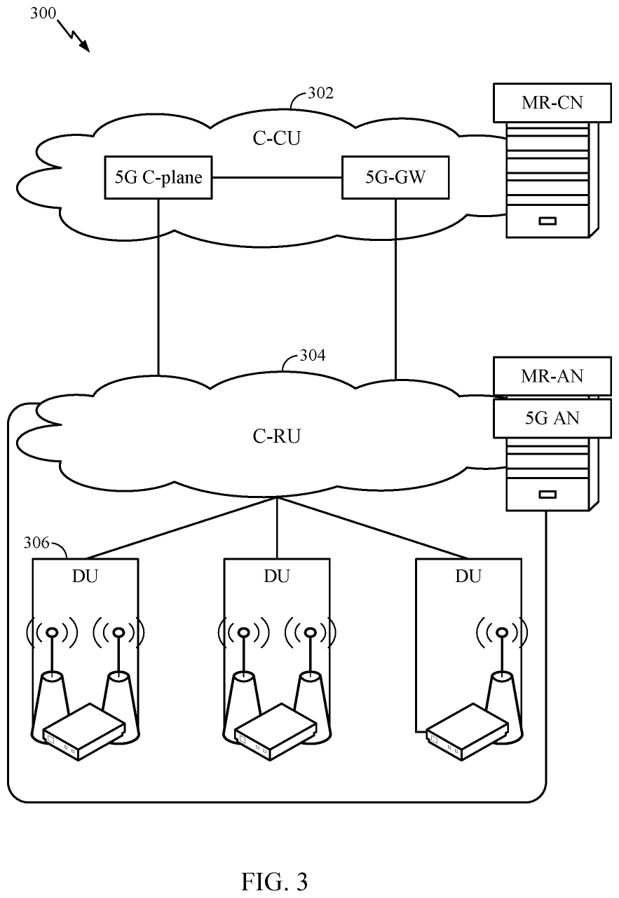

FIG. 3 illustrates an example physical architecture of a distributed RAN 300, according to aspects of the present disclosure. A centralized core network unit (C-CU) 302 may host core network functions. The C-CU may be centrally deployed. C-CU functionality may be offloaded (e.g., to advanced wireless services (AWS)), in an effort to handle peak capacity.

A centralized RAN unit (C-RU) 304 may host one or more ANC functions. Optionally, the C-RU may host core network functions locally. The C-RU may have distributed deployment. The C-RU may be closer to the network edge.

A DU 306 may host one or more TRPs (edge node (EN), an edge unit (EU), a radio head (RH), a smart radio head (SRH), or the like). The DU may be located at edges of the network with radio frequency (RF) functionality.

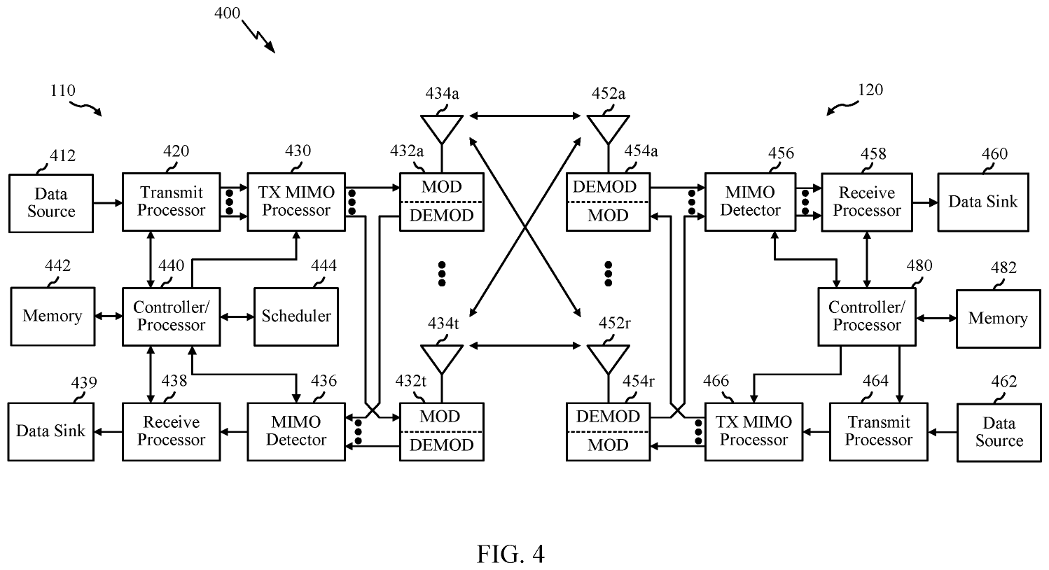

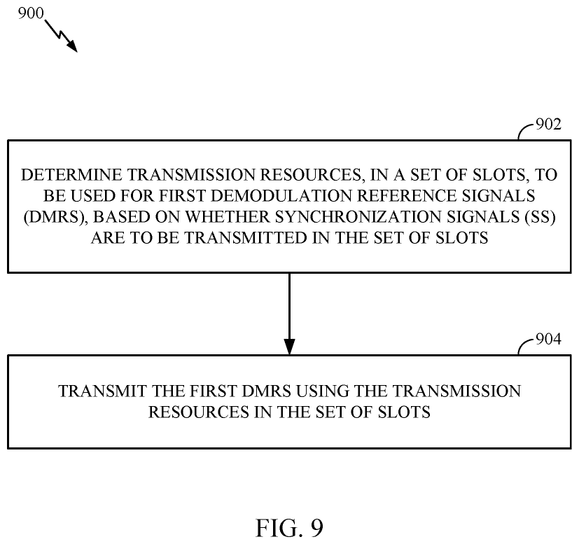

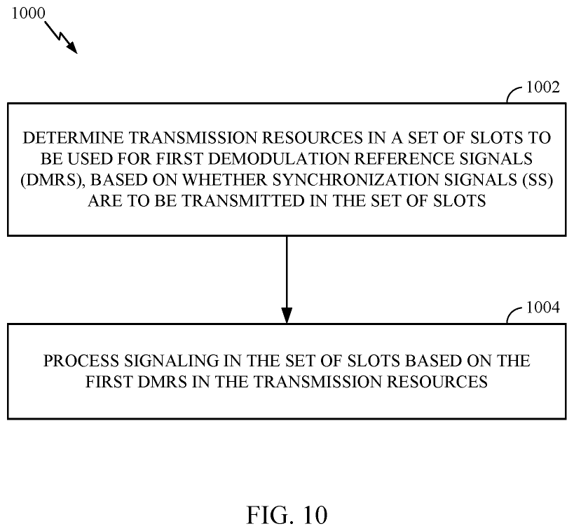

FIG. 4 illustrates example components of the BS 110 and UE 120 illustrated in FIG. 1, which may be used to implement aspects of the present disclosure. As described above, the BS may include a TRP. One or more components of the BS 110 and UE 120 may be used to practice aspects of the present disclosure. For example, antennas 452, Tx/Rx 222, processors 466, 458, 464, and/or controller/processor 480 of the UE 120 and/or antennas 434, processors 460, 420, 438, and/or controller/processor 440 of the BS 110 may be used to perform the operations described herein and illustrated with reference to FIGS. 9-10.

At the base station 110, a transmit processor 420 may receive data from a data source 412 and control information from a controller/processor 440. The control information may be for the Physical Broadcast Channel (PBCH), Physical Control Format Indicator Channel (PCFICH), Physical Hybrid ARQ Indicator Channel (PHICH), Physical Downlink Control Channel (PDCCH), etc. The data may be for the Physical Downlink Shared Channel (PDSCH), etc. The processor 420 may process (e.g., encode and symbol map) the data and control information to obtain data symbols and control symbols, respectively. The processor 420 may also generate reference symbols, e.g., for the PSS, SSS, and cell-specific reference signal. A transmit (TX) multiple-input multiple-output (MIMO) processor 430 may perform spatial processing (e.g., precoding) on the data symbols, the control symbols, and/or the reference symbols, if applicable, and may provide output symbol streams to the modulators (MODs) 432a through 432t. For example, the TX MIMO processor 430 may perform certain aspects described herein for RS multiplexing. Each modulator 432 may process a respective output symbol stream (e.g., for OFDM, etc.) to obtain an output sample stream. Each modulator 432 may further process (e.g., convert to analog, amplify, filter, and upconvert) the output sample stream to obtain a downlink signal. Downlink signals from modulators 432a through 432t may be transmitted via the antennas 434a through 434t, respectively.

At the UE 120, the antennas 452a through 452r may receive the downlink signals from the base station 110 and may provide received signals to the demodulators (DEMODs) 454a through 454r, respectively. Each demodulator 454 may condition (e.g., filter, amplify, downconvert, and digitize) a respective received signal to obtain input samples. Each demodulator 454 may further process the input samples (e.g., for OFDM, etc.) to obtain received symbols. A MIMO detector 456 may obtain received symbols from all the demodulators 454a through 454r, perform MIMO detection on the received symbols if applicable, and provide detected symbols. For example, MIMO detector 456 may provide detected RS transmitted using techniques described herein. A receive processor 458 may process (e.g., demodulate, deinterleave, and decode) the detected symbols, provide decoded data for the UE 120 to a data sink 460, and provide decoded control information to a controller/processor 480. According to one or more cases, CoMP aspects can include providing the antennas, as well as some Tx/Rx functionalities, such that they reside in distributed units. For example, some Tx/Rx processings can be done in the central unit, while other processing can be done at the distributed units. For example, in accordance with one or more aspects as shown in the diagram, the BS mod/demod 432 may be in the distributed units.

On the uplink, at the UE 120, a transmit processor 464 may receive and process data (e.g., for the Physical Uplink Shared Channel (PUSCH)) from a data source 462 and control information (e.g., for the Physical Uplink Control Channel (PUCCH) from the controller/processor 480. The transmit processor 464 may also generate reference symbols for a reference signal. The symbols from the transmit processor 464 may be precoded by a TX MIMO processor 466 if applicable, further processed by the demodulators 454a through 454r (e.g., for SC-FDM, etc.), and transmitted to the base station 110. At the BS 110, the uplink signals from the UE 120 may be received by the antennas 434, processed by the modulators 432, detected by a MIMO detector 436 if applicable, and further processed by a receive processor 438 to obtain decoded data and control information sent by the UE 120. The receive processor 438 may provide the decoded data to a data sink 439 and the decoded control information to the controller/processor 440.

The controllers/processors 440 and 480 may direct the operation at the base station 110 and the UE 120, respectively. The processor 440 and/or other processors and modules at the base station 110 may perform or direct, e.g., the execution of the functional blocks illustrated in FIGS. 9-10, and/or other processes for the techniques described herein. The processor 480 and/or other processors and modules at the UE 120 may also perform or direct processes for the techniques described herein. The memories 442 and 482 may store data and program codes for the BS 110 and the UE 120, respectively. A scheduler 444 may schedule UEs for data transmission on the downlink and/or uplink.

FIG. 5 illustrates a diagram 500 showing examples for implementing a communications protocol stack, according to aspects of the present disclosure. The illustrated communications protocol stacks may be implemented by devices operating in a in a 5G system (e.g., a system that supports uplink-based mobility). Diagram 500 illustrates a communications protocol stack including a Radio Resource Control (RRC) layer 510, a Packet Data Convergence Protocol (PDCP) layer 515, a Radio Link Control (RLC) layer 520, a Medium Access Control (MAC) layer 525, and a Physical (PHY) layer 530. In various examples the layers of a protocol stack may be implemented as separate modules of software, portions of a processor or ASIC, portions of non-collocated devices connected by a communications link, or various combinations thereof. Collocated and non-collocated implementations may be used, for example, in a protocol stack for a network access device (e.g., ANs, CUs, and/or DUs) or a UE.

A first option 505-a shows a split implementation of a protocol stack, in which implementation of the protocol stack is split between a centralized network access device (e.g., an ANC 202 in FIG. 2) and distributed network access device (e.g., DU 208 in FIG. 2). In the first option 505-a, an RRC layer 510 and a PDCP layer 515 may be implemented by the central unit, and an RLC layer 520, a MAC layer 525, and a PHY layer 530 may be implemented by the DU. In various examples the CU and the DU may be collocated or non-collocated. The first option 505-a may be useful in a macro cell, micro cell, or pico cell deployment.

A second option 505-b shows a unified implementation of a protocol stack, in which the protocol stack is implemented in a single network access device (e.g., access node (AN), new radio base station (NR BS), a new radio Node-B (NR NB), a network node (NN), or the like.). In the second option, the RRC layer 510, the PDCP layer 515, the RLC layer 520, the MAC layer 525, and the PHY layer 530 may each be implemented by the AN. The second option 505-b may be useful in a femto cell deployment.

Regardless of whether a network access device implements part or all of a protocol stack, a UE may implement an entire protocol stack 505-c (e.g., the RRC layer 510, the PDCP layer 515, the RLC layer 520, the MAC layer 525, and the PHY layer 530).

FIG. 6 is a diagram 600 showing an example of a DL-centric subframe. The DL-centric subframe may include a control portion 602. The control portion 602 may exist in the initial or beginning portion of the DL-centric subframe. The control portion 602 may include various scheduling information and/or control information corresponding to various portions of the DL-centric subframe. In some configurations, the control portion 602 may be a physical DL control channel (PDCCH), as indicated in FIG. 6. The DL-centric subframe may also include a DL data portion 604. The DL data portion 604 may sometimes be referred to as the payload of the DL-centric subframe. The DL data portion 604 may include the communication resources utilized to communicate DL data from the scheduling entity (e.g., UE or BS) to the subordinate entity (e.g., UE). In some configurations, the DL data portion 604 may be a physical DL shared channel (PDSCH).

The DL-centric subframe may also include a common UL portion 606. The common UL portion 606 may sometimes be referred to as an UL burst, a common UL burst, and/or various other suitable terms. The common UL portion 606 may include feedback information corresponding to various other portions of the DL-centric subframe. For example, the common UL portion 606 may include feedback information corresponding to the control portion 602. Non-limiting examples of feedback information may include an ACK signal, a NACK signal, a HARQ indicator, and/or various other suitable types of information. The common UL portion 606 may include additional or alternative information, such as information pertaining to random access channel (RACH) procedures, scheduling requests (SRs), and various other suitable types of information. As illustrated in FIG. 6, the end of the DL data portion 604 may be separated in time from the beginning of the common UL portion 606. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric subframe and alternative structures having similar features may exist without necessarily deviating from the aspects described herein.

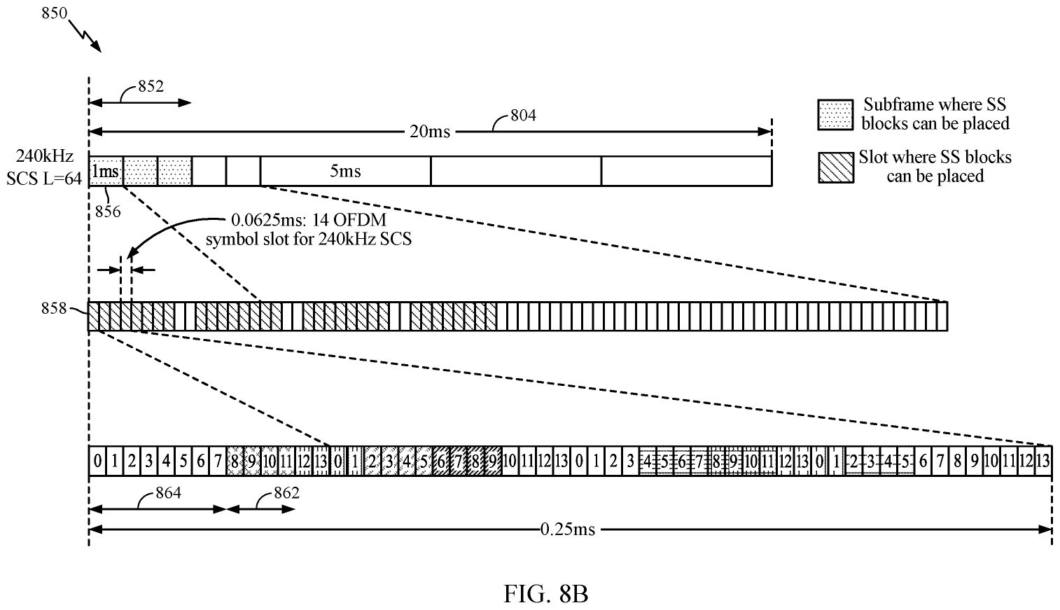

While the subframe illustrated in FIG. 6 is shown as being one transmission time interval (TTI), in some numerologies in NR, such as those using a subcarrier spacing (SCS) or more than 15 kHz, a subframe may be divided into a plurality of slots. A subframe divided into a plurality of slots is discussed below, with reference to FIG. 8.

FIG. 7 is a diagram 700 showing an example of an UL-centric subframe. The UL-centric subframe may include a control portion 702. The control portion 702 may exist in the initial or beginning portion of the UL-centric subframe. The control portion 702 in FIG. 7 may be similar to the control portion described above with reference to FIG. 6. The UL-centric subframe may also include an UL data portion 704. The UL data portion 704 may sometimes be referred to as the payload of the UL-centric subframe. The UL data portion may refer to the communication resources utilized to communicate UL data from the subordinate entity (e.g., UE) to the scheduling entity (e.g., UE or BS). In some configurations, the control portion 702 may be a physical DL control channel (PDCCH).

As illustrated in FIG. 7, the end of the control portion 702 may be separated in time from the beginning of the UL data portion 704. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric subframe may also include a common UL portion 706. The common UL portion 706 in FIG. 7 may be similar to the common UL portion 706 described above with reference to FIG. 7. The common UL portion 706 may additionally or alternatively include information pertaining to channel quality indicator (CQI), sounding reference signals (SRSs), and various other suitable types of information. One of ordinary skill in the art will understand that the foregoing is merely one example of an UL-centric subframe and alternative structures having similar features may exist without necessarily deviating from the aspects described herein.

While the subframe illustrated in FIG. 7 is shown as being one transmission time interval (TTI), in some numerologies in NR, such as those using a subcarrier spacing (SCS) or more than 15 kHz, a subframe may be divided into a plurality of slots. A subframe divided into a plurality of slots is discussed below, with reference to FIG. 8.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

A UE may operate in various radio resource configurations, including a configuration associated with transmitting pilots using a dedicated set of resources (e.g., a radio resource control (RRC) dedicated state, etc.) or a configuration associated with transmitting pilots using a common set of resources (e.g., an RRC common state, etc.). When operating in the RRC dedicated state, the UE may select a dedicated set of resources for transmitting a pilot signal to a network. When operating in the RRC common state, the UE may select a common set of resources for transmitting a pilot signal to the network. In either case, a pilot signal transmitted by the UE may be received by one or more network access devices, such as an AN, or a DU, or portions thereof. Each receiving network access device may be configured to receive and measure pilot signals transmitted on the common set of resources, and also receive and measure pilot signals transmitted on dedicated sets of resources allocated to the UEs for which the network access device is a member of a monitoring set of network access devices for the UE. One or more of the receiving network access devices, or a CU to which receiving network access device(s) transmit the measurements of the pilot signals, may use the measurements to identify serving cells for the UEs, or to initiate a change of serving cell for one or more of the UEs.

### Example Multiplexing Demodulation Reference Signals with Synchronization Signals in New Radio

Under 3GPP's 5G (also referred to as new radio (NR)) wireless communication standards, a structure has been defined for NR synchronization (synch) signals (NR-SS), also referred to as NR synchronization channels. Under 5G, a set of consecutive OFDM symbols carrying synch signals (e.g., primary synchronization signal (PSS), secondary synchronization signal (SSS), and/or PBCH) forms an SS block. In some cases, a set of one or more SS blocks may form an SS burst. In addition, different SS blocks may be transmitted on different beams to achieve beam-sweeping for synch signals, which may be used by a UE to quickly identify and acquire a cell. Further, one or more of the channels in an SS block may be used for measurements. Such measurements may be used for various purposes such as radio link management (RLM), beam management, etc. For example, a UE may measure the cell quality and report the quality back in the form of a measurement report, which may be used by the base station for beam management and other purposes.

The NR-SS may not be transmitted in the entire bandwidth of a new radio communications system. In an NR communications system, certain physical resource blocks (PRBs) within the SS bandwidth, which is a subset of the entire bandwidth, may contain SS blocks. Each SS block may include four OFDM symbols. PRBs (also referred to as resource blocks (RBs) that are not within the SS bandwidth do not carry SS blocks. The PRBs that are within the SS bandwidth and containing SS blocks may also carry PDSCH data. The PDSCH data is typically transmitted with corresponding demodulation reference signals (DMRS) to aid a receiving device in determining the channel state and receiving the PDSCH data.

According to aspects of the present disclosure, techniques are provided for determining transmission resources to use for transmitting DMRS in PRBs that are within the SS bandwidth and may contain SS blocks.

In aspects of the present disclosure, techniques are provided for transmitting and receiving transmissions that are conveyed in a set of resource blocks in which some resource blocks contain SS blocks while other resource blocks do not contain SS blocks.

FIGS. 8A & 8B illustrate exemplary transmission timelines 800 and 850 of synchronization signals for a new radio telecommunications system, in accordance with aspects of the present disclosure. A BS, such as BS 110a shown in FIG. 1, may transmit SS in one period (e.g. 5 subframes) 802 during each 20 ms period 804. As mentioned above, a subframe 806 can be divided into a plurality of slots 808. For example, in a communications system using a subcarrier spacing (SCS) of 120 kHz, a subframe may be divided into eight slots, each 0.125 ms long. Each slot may include 14 OFDM symbols 810. The BS may transmit an SS block 812 of up to four consecutive OFDM symbols during one or more slots. The BS may transmit different SS blocks using different transmit beams (e.g., for beam-sweeping). Each SS block may include, for example, a primary synchronization signal (PSS), a secondary synchronization signal (SSS), and one or more physical broadcast channels (PBCHs), also referred to as synchronization channels. Symbols that are not used for SS, such as the symbols 814, may be used for transmitting PDCCH, PDSCH, and other channels.

In the exemplary transmission timeline 850 shown in FIG. 8B, each subframe 856 is divided into 16 slots 858 that are each 0.0625 ms long, as may be used in a wireless communications system using an SCS of 240 kHz. A BS, such as BS 110a shown in FIG. 1, may transmit SS in one period (e.g. 3 subframes) 852 during each 20 ms period 854. While the length of a slot and an OFDM symbol may vary depending on the SCS used, the SS blocks 862 and 812 (see FIG. 8A) are up to four OFDM symbols long. Symbols that are not used for SS, such as the symbols 864, may be used for transmitting PDCCH, PDSCH, and other channels.

FIG. 9 illustrates example operations for wireless communications by a base station (BS), such as BS 110a shown in FIG. 1, in accordance with aspects of the present disclosure.

Operations 900 begin, at block 902, with the BS determining transmission resources, in a set of slots, to be used for first demodulation reference signals (DMRS), based on whether synchronization signals (SS) are to be transmitted in the set of slots. For example, BS 110a determines transmission resources (e.g., resource elements in a set of OFDM symbols, such as OFDM symbols 814 shown in FIG. 8A), in a set of slots (e.g., slots 802 in FIG. 8A), to be used for first DMRS (e.g., DMRS accompanying a PDSCH to be used by a receiving device in demodulating the PDSCH), based on whether SS are to be transmitted in the set of slots.

At block 904, operations 900 continue with the BS transmitting the first DMRS using the transmission resources in the set of slots. Continuing the example, BS 110a transmits the first DMRS using the transmission resources (e.g., the resource elements determined at block 902) in the set of slots.

FIG. 10 illustrates example operations for wireless communications by a user equipment (UE), such as UE 120 shown in FIG. 1, in accordance with aspects of the present disclosure.

Operations 1000 begin, at block 1002, with the UE determining transmission resources in a set of slots to be used for first demodulation reference signals (DMRS), based on whether synchronization signals (SS) are to be transmitted in the set of slots. For example, UE 120 determines transmission resources (e.g., resource elements) in a set of slots to be used for DMRS, based on whether SS are to be transmitted in the set of slots.

At block 1004, operations 1000 continue with the UE processing signaling in the set of slots based on the first DMRS in the transmission resources. Continuing the example, UE 120 processes signaling (e.g., a PDSCH) in the set of slots based on the DMRS in the transmission resources (e.g., the resource elements determined in block 1002).

According to aspects of the present disclosure, a base station (e.g., an eNodeB, a next generation NodeB (gNB)) may determine not to transmit an SS block in slots where SS blocks may be present (e.g., in the slots 814 in exemplary timeline 800 in FIG. 8A). The BS may indicate this (i.e., that the BS is not transmitting an SS block in slots where SS blocks may be present) to connected UEs via various techniques, e.g., a DCI, a group-common PDCCH and/or DCI, RRC signaling, or via system information broadcast (SIB) messages.

In aspects of the present disclosure, a BS may transmit and a UE may process DMRS designed according to a pattern that assumes an SS block is always present. The DMRS is punctured by any potential SS. This technique may be inefficient in terms of resource usage, as some resources are unused when the BS determines not to transmit an SS block in slots where SS blocks may be present.

According to aspects of the present disclosure, a BS may transmit and a UE may process DMRS according to a pattern determined based on whether an SS block is present in a slot, as described above with reference to FIGS. 9-10. For example, if a BS determines not to transmit an SS block in slots where SS blocks may be present, then the BS transmits and a receiving UE processes DMRS according to a “usual” DMRS pattern, i.e., a DMRS pattern that is the same as that used for RBs that are outside the SS bandwidth. In a second example, if the BS determines to transmit only one SS block in a slot where two SS blocks may be present (e.g., the BS transmits a PSS, but not a PBCH), DMRS that would have been punctured by the missing SS block is not punctured. The transmitted SS block still punctures any DMRS with which the SS block overlaps.

In aspects of the present disclosure, a DMRS pattern used for RBs that may contain SS blocks may be different from a DMRS pattern used for RBs that can never contain SS blocks.

According to aspects of the present disclosure, a DMRS pattern for a DMRS transmitted in an RB may be determined based on a set of time and/or frequency locations of SS within the RB. For example, a DMRS pattern used in the first slot of the slots 808 (see FIG. 8A) in exemplary timeline 800 may be different from a DMRS pattern used in the second slot of the slots 808, because the time resources used for SS blocks in the first slot (i.e., OFDM symbols 4-11, shown at 810) differ from the time resources used for SS blocks in the second slot (i.e., OFDM symbols 2-9, shown at 810).

In aspects of the present disclosure, a DMRS pattern for a DMRS may also depend on a mini-slot structure, if mini-slot scheduling is used by the BS.

According to aspects of the present disclosure, an allocation of physical resource blocks (PRBs, e.g., for a downlink transmission) can be partitioned into groups or bundles, such that a precoder (e.g., a precoding matrix) used in transmitting is the same for all PRBs within a group. Using a same precoder for all of the PRBs within a group allows a receiver (e.g., a UE) to do joint channel estimation using all DMRS of all PRBs within the group.

In aspects of the present disclosure, a bundle in which some PRBs never carry SS and some may or may not carry SS is referred to as a mixed bundle.

According to aspects of the present disclosure, a mixed bundle may be prohibited, such that a grant, e.g., conveyed by a transmission on a channel such as PDCCH, that indicates such an assignment, is treated by a receiving UE as a false-CRCpass of the transmission conveying the grant, thus resulting in the UE ignoring the transmission and any allocation carried in the transmission. If mixed bundles are prohibited, then fewer joint-DMRS patterns exist to be used for channel estimation.

In aspects of the present disclosure, a communications system (e.g., a BS and/or a UE) may use implicit modification of bundling rules to avoid mixed bundles. If the communications system uses implicit modification, then the system may avoid using special signaling to indicate how to handle the mixed bundle. For example, a communications system may treat any mixed bundle as two separate bundles, a bundle A containing PRBs that can never carry SS, and a bundle B containing the other PRBs. In the example, if a UE has been informed that certain PRBs in bundle B don't carry SS, then those PRBs may be moved to bundle A.

According to aspects of the present disclosure, implicit modification of bundling rules also implies a reduction of a bundle-size. For example, a BS may assign RBs 1-16 with a bundle-size of 8 (implying 2 bundles) for a DL transmission, but if RBs 1-4 are punctured by SS, thus indicating there is 1 mixed bundle and 1 non-mixed bundle, then the BS and any receiving UE may treat the RBs by changing to a bundle-size of 4, which results in the assignment including 4 non-mixed bundles, only 1 (i.e., RBs 1-4) of which contains SS.

In aspects of the present disclosure, implicit modification of bundling rules may include a limit to the reduction in bundle size, with grants that need to overstep the limit (e.g., a bundle of 8 RBs with SS in the first 4 RBs and a limit that no bundle may be reduced in size by ½) treated as falseCrcPass and ignored by a receiving UE. The limit may be an absolute limit, with bundles not being smaller than an absolute number of RBs (e.g., 4 RBs), or a relative limit, with bundles not being smaller than a fraction of the original allocation (e.g., ¼ of the original allocation), or some combination thereof.

According to aspects of the present disclosure, the above described rules for bundle modification may depend on the type of mixed bundle, where ‘type’ refers to the particular locations and number of SS symbols, e.g., some RBs are punctured only by PBCH while others are punctured by PSS and/or SSS. Similarly, in some RBs, some OFDM symbols carrying SS may have SS symbols occupying all the subcarriers of the RB, whereas in some RBs, they may only occupy some of the subcarriers of the RB. This may happen, for example, if the sequence-length for the PSS and/or SSS sequences is not a multiple of the number of subcarriers per RB. Note that the rules for DMRS pattern determination may also depend on the exact locations (e.g., resource elements) of the SS symbols.

In aspects of the present disclosure, for a PDSCH in a same RB as an SS block, the transmitting BS uses one or more of the above-described DMRS rules, and then rate-matches the PDSCH around resulting DMRS and SS in the RB.

According to aspects of the present disclosure, DMRS puncturing by SS can destroy orthogonality of orthogonal cover code (OCC) overlays used to multiplex multiple layers or multiple UEs over the same RB. That is, when some DMRS using OCC overlays are not transmitted because the DMRS are punctured by SS, then the remaining DMRS may not be fully orthogonal.

In aspects of the present disclosure, a communications system (e.g., a BS and/or a UE) may restrict rank used for MIMO transmissions in the RBs with punctured DMRS, to prevent the punctured DMRS and destroyed orthogonality (e.g., as described above) from preventing the communication from being properly received.

According to aspects of the present disclosure, a communications system may disallow use of higher ranks, if an assignment includes certain types of DMRS and/or puncturing.

In aspects of the present disclosure, a communications system may implicitly restrict ranks used for a transmission, depending on a DMRS and/or puncturing type used in the transmission. The implicit restriction may apply to an entire assignment or only to the punctured RBs.

According to aspects of the present disclosure, the techniques described above for RBs punctured by SS blocks can be extended to RBs punctured by other sporadic signals, such as channel state information reference signals (CSIRS) or tracking reference signals (TRS) on DL transmissions or sounding reference signals (SRS) on UL transmissions, or resources indicated to be rate-matched around or resources reserved for forward compatibility.

The treatment of mixed bundles may also depend on the waveform type associated with the corresponding transmission, for both uplink and downlink. For example, if discrete Fourier transform single-carrier orthogonal frequency division multiplexing (DFT-s-OFDM) waveform is used, then mixed bundles may be disallowed as mentioned as previously, as different precoding on different RBs or selective puncturing of certain RBs or tones will impact the low peak to average power ratio (low-PAPR) property of DFT-s-OFDM. In another aspect, mixed bundles may still be allowed in this case, with the understanding that the PAPR of the transmission will be increased. The behavior may also depend on UE capability.

In aspects of the present disclosure, the techniques described above for RBs punctured by SS blocks can be extended to ultra-reliable low latency communications (URLLC) and/or grant-free UL transmissions.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, means for transmitting and/or means for receiving may comprise one or more of a transmit processor 420, a TX MIMO processor 430, a receive processor 438, or antenna(s) 434 of the base station 110 and/or the transmit processor 464, a TX MIMO processor 466, a receive processor 458, or antenna(s) 452 of the user equipment 120. Additionally, means for determining, means for processing, means for generating, means for multiplexing, and/or means for applying may comprise one or more processors, such as the controller/processor 440 of the base station 110 and/or the controller/processor 480 of the user equipment 120.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications, comprising:
determining transmission resources, in a set of slots, to be used for first demodulation reference signals (DMRS), based on whether an uplink (UL) transmission is to be transmitted in the set of slots; and
transmitting the first DMRS using the transmission resources in the set of slots.

2. The method of claim 1, wherein the UL transmission comprises a grant-free UL transmission.

3. The method of claim 1, further comprising:
transmitting an indication of whether the UL transmission is to be transmitted in the set of slots.

4. The method of claim 1, wherein the set of slots contains a first bundle of physical resource blocks (PRBs) in which the UL transmission is to be transmitted and a second bundle of PRBs in which the UL transmission is not to be transmitted, and the method further comprises:
transmitting the first DMRS and first data in the first bundle of PRBs using a first precoding matrix; and
transmitting second DMRS and second data in the second bundle of PRBs using a second precoding matrix.

5. The method of claim 1, further comprising:
determining a rank to be used in transmitting data in the set of slots, based on the determined transmission resources for the first DMRS.

6. The method of claim 1, wherein the UL transmission comprises an ultra-reliable low latency communications (URLLC) transmission.

7. The method of claim 1, wherein the UL transmission comprises a sounding reference signal (SRS) and wherein determining the transmission resources comprises determining resource blocks (RBs) that are not used for transmitting the SRS.

8. A method for wireless communications, comprising:
determining transmission resources in a set of slots to be used for first demodulation reference signals (DMRS), based on whether an UL transmission is to be transmitted in the set of slots; and
processing signaling in the set of slots based on the first DMRS in the transmission resources.

9. The method of claim 8, wherein the UL transmission comprises a grant-free UL transmission.

10. The method of claim 8, further comprising:
receiving an indication of whether the UL transmission is to be transmitted in the set of slots; and
determining whether the UL transmission is to be transmitted in the set of slots based on the indication.

11. The method of claim 8, wherein the set of slots contains a first bundle of physical resource blocks (PRBs) in which the UL transmission is to be transmitted and a second bundle of PRBs in which the UL transmission is not to be transmitted, and the method further comprises:
processing the first DMRS, punctured by the UL transmission, and first data in the first bundle of PRBs using a first precoding matrix; and
processing second DMRS and second data in the second bundle of PRBs using a second precoding matrix.

12. The method of claim 11, further comprising:
receiving an indication that the UL transmission is to be transmitted in the set of slots;
determining the first bundle of PRBs in the set of slots, based on the indication; and
determining the second bundle of PRBs in the set of slots, based on the first bundle of PRBs.

13. The method of claim 8, wherein the set of slots contains a first bundle of physical resource blocks (PRBs) in which the UL transmission is to be transmitted and a second bundle of PRBs in which the UL transmission is not to be transmitted, and the method further comprises:
obtaining an indication that a mixed bundle of PRBs is disallowed; and
determining, based on the indication, to not process:
the first DMRS and first data in the first bundle of PRBs, and
second DMRS and second data in the second bundle of PRBs.

14. The method of claim 8, further comprising:
determining a rank to be used in a downlink (DL) transmission in the set of slots, based on the determined transmission resources for the first DMRS.

15. The method of claim 8, wherein the UL transmission comprises an ultra-reliable low latency communications (URLLC) transmission.

16. The method of claim 8, wherein the UL transmission comprises a sounding reference signal (SRS) and wherein determining the transmission resources comprises determining resource blocks (RBs) that are not used for transmitting the SRS.

17. The method of claim 8, further comprising transmitting the UL transmission.

18. In a wireless communications system, an apparatus comprising:
a memory; and
a processor coupled to the memory and configured to:
determine transmission resources, in a set of slots, to be used for first demodulation reference signals (DMRS), based on whether an uplink (UL) transmission is to be transmitted in the set of slots; and
cause the apparatus to transmit the first DMRS using the transmission resources in the set of slots.

19. The apparatus of claim 18, wherein the UL transmission comprises a grant-free UL transmission.

20. The apparatus of claim 18, wherein the processor is further configured to:
cause the apparatus to transmit an indication of whether the UL transmission is to be transmitted in the set of slots.

21. The apparatus of claim 18, wherein the set of slots contains a first bundle of physical resource blocks (PRBs) in which the UL transmission is to be transmitted and a second bundle of PRBs in which the UL transmission is not to be transmitted, and the processor is further configured to:
cause the apparatus to transmit the first DMRS and first data in the first bundle of PRBs using a first precoding matrix; and
cause the apparatus to transmit second DMRS and second data in the second bundle of PRBs using a second precoding matrix.

22. The apparatus of claim 18, wherein the processor is further configured to:
determine a rank to be used in transmitting data in the set of slots, based on the determined transmission resources for the first DMRS.

23. The apparatus of claim 18, wherein the UL transmission comprises an ultra-reliable low latency communications (URLLC) transmission.

24. The apparatus of claim 18, wherein the UL transmission comprises a sounding reference signal (SRS) and wherein the processor is configured to determine the transmission resources by determining resource blocks (RBs) that are not used for transmitting the SRS.

25. In a wireless communications system, an apparatus comprising:
a memory; and
a processor configured to:
determine transmission resources in a set of slots to be used for first demodulation reference signals (DMRS), based on whether an uplink (UL) transmission is to be transmitted in the set of slots; and
process signaling in the set of slots based on the first DMRS in the transmission resources.

26. The apparatus of claim 25, wherein the UL transmission comprises a grant-free UL transmission.

27. The apparatus of claim 25, wherein the processor is further configured to:
cause the apparatus to receive an indication of whether the UL transmission is to be transmitted in the set of slots; and
determine whether the UL transmission is to be transmitted in the set of slots based on the indication.

28. The apparatus of claim 25, wherein the set of slots comprises a first bundle of physical resource blocks (PRBs) in which the UL transmission is to be transmitted and a second bundle of PRBs in which the UL transmission is not to be transmitted, and the processor is further configured to:
process the first DMRS, punctured by the UL transmission, and first data in the first bundle of PRBs using a first precoding matrix; and
process second DMRS and second data in the second bundle of PRBs using a second precoding matrix.

29. The apparatus of claim 28, wherein the processor is further configured to:
receive an indication that the UL transmission is to be transmitted in the set of slots;
determine the first bundle of PRBs in the set of slots, based on the indication; and
determine the second bundle of PRBs in the set of slots, based on the first bundle of PRBs.

30. The apparatus of claim 25, wherein the set of slots contains a first bundle of physical resource blocks (PRBs) in which the UL transmission is to be transmitted and a second bundle of PRBs in which the UL transmission is not to be transmitted, and the processor is further configured to:
obtain an indication that a mixed bundle of PRBs is disallowed; and
determine, based on the indication, to not process:
the first DMRS and first data in the first bundle of PRBs, and
second DMRS and second data in the second bundle of PRBs.

31. The apparatus of claim 25, wherein the processor is further configured to:
determine a rank to be used in a downlink (DL) transmission in the set of slots, based on the determined transmission resources for the first DMRS.

32. The apparatus of claim 25, wherein the UL transmission comprises an ultra-reliable low latency communications (URLLC) transmission.

33. The apparatus of claim 25, wherein the processor is further configured to transmit the UL transmission.
